(19) United States
(12) Patent Application Publication
(10) Pub. No.: US 2004/0052234 A1
(43) Pub. Date: Mar. 18, 2004

(54) Method and system for dispatching multiple TCP packets from communication systems

(75) Inventors: Pablo Ameigeiras, Aalborg (DK); Eero Sillasto, Helsinki (FI); Jeroen Wigard, Aalborg (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/631,805

(22) Filed: Aug. 1, 2003

Related U.S. Application Data
(63) Continuation of application No. PCT/FI01/01054, filed on Dec. 4, 2001.

(51) Int. Cl. H04Q 7/00; H04L 12/54

(52) U.S. Cl. 370/338; 370/328; 370/474; 370/428

(57) ABSTRACT

The present invention relates to mobile telecommunication systems. The present invention overcomes the problem of unnecessary retransmissions over the air interface. These transmissions waste the capacity of the air interface. In a preferred embodiment, a Discarding TCP Packets (DTCPP) entity is added to the PDCP layer. The DTCPP entity has the knowledge of the correspondence between the PDCP sequence numbering and the TCP segments sequence numbering correspondence. Further, the DTCPP entity has the knowledge of which TCP segments have been successfully received by the TCP-UE. This knowledge can be gained reading the TCP acknowledgements at the UL PDCP, where the sequence number of the correctly received byte is stated. The present invention describes a method and system for avoiding multiple transmissions of the same TCP segment.

### FIELD OF THE INVENTION

The present invention relates to mobile telecommunication systems. In particular, the present invention relates to a novel and improved method and system for avoiding multiple transmissions of the same TCP packet in a wireless communication system.

### BACKGROUND OF THE INVENTION

Above the IP layer of the Internet protocol (IP) structure one service which is provided is a reliable transport service which is typically called the “reliable stream transport service”, defined by the Transmission Control Protocol (TCP). Although the TCP is provided over the Internet, it is in fact an independent general-purpose protocol, which can also be used with other delivery systems.

The TCP provides a reliable stream delivery service, which can be contrasted with the Unreliable Datagram Protocol (UDP), which is also provided over the Internet. Whereas the UDP provides an unreliable delivery service because delivery is not guaranteed, the TCP provides a more complex structure which does ensure reliable delivery in the form of a stream.

The UDP provides unreliable packet delivering, whereby packets may be lost or destroyed when transmission errors interfere with data, when network hardware fails, or when networks become too heavily loaded to accommodate the load presented. The TCP on the other hand operates by providing delivery by means of a stream of bits, divided into eight-bit octets or bytes.

Given that the underlying Internet protocol is unreliable, TCP transmissions operate in accordance with a technique known as positive acknowledgement with retransmission. The technique requires a recipient to communicate with the source, sending back an acknowledgement message every time it receives data. The sender keeps a record of each packet that it sends and waits for an acknowledgement before sending the next packet. The sender also starts a timer when it sends its packet and retransmits a packet if the timer expires before the acknowledgement arrives.

The sender, e.g. a router, sends a packet to the receiver via the network and starts a timer for the message. When the receiver receives the packet, the receiver then sends an acknowledgement. When the acknowledgement is received on the sender's side, the sender can cancel the timer and send the next packet to the receiver, setting a timer for the message. When the receiver receives the next packet, it sends a second acknowledgement to the sender. Once again the sender can cancel the timer. The time between sending a packet and receiving an acknowledgement of the packet is called Round Trip Time (RTT). The process then continues with the transmission of further packets on receipt of the second acknowledgement.

Whenever a server transmits a segment, it has to reach the client and the client acknowledges the transmitted segment. The TCP sender holds a variable used to calculate an estimation of the maximum allowed RTT. This variable is called the RTO (Retransmission Timeout). Moreover, the server has a timer that counts the elapsed time since the segment was transmitted. If the corresponding acknowledgement does not arrive at the server before the timer reaches the value of the RTO estimator, the server considers that congestion occurred in the network and starts the retransmission of all segments that were pending acknowledgements.

The basic transfer protocol has the disadvantage that an acknowledgement must be received before a further packet can be sent. In order to increase the dataflow, an Internet stream service can employ a concept known as a “sliding window”. The sliding window approach allows a sequence of packets to be transmitted before receiving an acknowledgement. The number of packets, which can be transmitted before receiving an acknowledgement, is defined by the number of packets within the “window”. Accordingly, for a sequence of packets 1-6, a window might extend from packet 1 to packet 3. Accordingly, all of the first three packets can be transmitted without waiting for an acknowledgement. However, packet 4 can only be transmitted when an acknowledgement has been received for packet 1. On receipt of the acknowledgement for packet 1, packet 4 is then sent. At this stage, packet 5 cannot be sent until an acknowledgement has been received from packet 2. It can be seen therefore that the window effectively slides along the sequence of packets as acknowledgements are received.

A sliding window protocol remembers which packets have been acknowledged and may keep a separate timer for each unacknowledged packet. If a packet is lost, the timer expires and the sender retransmits that packet. As the sender slides its window, it moves past an acknowledged packet. At the receiving end, a similar window is maintained, for accepting and acknowledging packets as they arrive. It will be appreciated that the protocol is relatively complex, but it provides a more efficient transfer.

The TCP specifies the format of the data and acknowledgements that two computers are to exchange to achieve reliable transfer, as well as the procedure to ensure that data arrives correctly. The TCP assumes very little about the underlying communication system and can be used with a variety of packet delivery systems including the Internet Protocol (IP) datagram delivery service. The TCP service resides above the IP layer, which in turn lies above the network interface of the Internet.

The consequence of the variations in the network load and of the queuing of packets by routers and sending stations is that the actual RTT can increase, due to the time that the packet is held in the queue. As a result, it is possible that unnecessary retransmission of packets can occur where an acknowledgement has not been received. The unnecessary retransmission of the packet leads to an unnecessary increase in the traffic capacity over the network, which can aggravate congestion on the network.

In the TCP, the data is split into what the protocol considers the optimum size chunks to transmit. The chunks are denominated segments and their size cannot exceed a maximum constant value (Maximum Segment Size or MSS). The TCP defines the congestion window (cwnd) that determines the amount of outstanding data that the sender can transmit.

A wireless network behaves differently than a fixed network, since the variances in delays are higher and the transmission medium causes more errors. In order to fix these transmission errors Radio Link Control (RLC) retransmissions (ARQ, Automatic Repeat Request) are used. The RLC protocol is specified, e.g. in the ETSI (European telecommunications Standards Institute) TS 125 322 V3.3.0 (2000-06). The RLC layer on both sides of the air interface takes care of the retransmissions of the RLC blocks. Every TCP segment is split into one or multiple RLC blocks. Every RLC block is positively (ACK) or negatively (NACK) acknowledged. If a NACK is received, the transmitting side (in the Node B or Radio Network Controller (RNC)) retransmits the RLC block.

Moreover, the PDCP (Packet Data Convergence Protocol) layer above the RLC layer keeps track of PDCP-PDUs (PDCP segments; PDU, Protocol Data Unit)) passed to the RLC layer by numbering the received packets from the upper layers. The PDCP is specified, e.g. in the ETSI TS 125 323 V3.2.0 (2000-06). The RLC informs the PDCP layer which PDCP-PDUs have been positively or negatively acknowledged. The PDCP layer also maintains for SRNS (SRNS, Serving Radio Network Subsystem) lossless relocation purposes all PDCP-PDUs that have been passed to the RLC but have not been positively/negatively acknowledged.

Several circumstances in the air interface (load congestion, bit rate modifications, etc.) may produce excess delay of TCP segments on the RLC buffer, and therefore cause a timeout at the TCP server SC. This will trigger the retransmission of one or several TCP segments by the server. FIG. 1 describes the different possible situations. FIG. 1 includes a TCP segment sender SC, which is preferably a server. FIG. 1 comprises also a Radio Network Controller (RNC), a Base Station (BS) and user equipment (UE). The TCP_Re refers to the retransmitted TCP segment(s). Now, when the retransmission occurs, there are several possible situations where the original TCP segment(s) can be. The RLC blocks corresponding to the original version of these TCP segments may be waiting in the RLC buffer (TCP_Ori1), they may be in the air (TCP_Ori2), they may just have been arrived at the destination (TCP_Ori3), or their TCP acknowledgement may be on its way back to the server SC (TCP_Ori4).

European patent application EP 0 912028 describes one solution to the TCP Ori1 alternative, wherein the solution takes care of duplicated TCP packets within the same buffer. However, at the PDCP layer buffer, the TCP sequence numbering is not available because the TCP segment headers are already compressed. This makes it impossible to check the duplicated TCP segments at this buffer. Moreover, the other cases (TCP_Ori2, TCP_Ori3, TCP_Ori4) where the original segment is not in the buffer but in the air, just being received or being acknowledged, are not covered.

The TCP tries to adapt the transmission rate to the load and capacity of the links of the network. This is done by several mechanisms, such as slow start, retransmission timeout, fast retransmission, etc. Fast retransmission and retransmission timeout cause retransmission of the TCP/IP packets, when they are lost or delayed more than the dynamic timer (RTO).

The behaviour of the wireless medium leads to the fact that timeouts can easily happen at the TCP layer, causing the retransmission of several TCP packets, while they are at the same time retransmitted at the RLC layer. This means that several packets are unnecessarily transmitted twice over the network, including the air interface. This is undesirable, since the air interface capacity is the limiting factor in the chain.

### SUMMARY OF THE INVENTION

The present invention describes a solution for avoiding multiple transmissions of the same TCP packet in a wireless telecommunication system. The invention overcomes the problem of unnecessary retransmissions over the air interface. These retransmissions waste the capacity of the air interface.

The present invention describes a method and system for managing the dispatching of TCP segments in a wireless telecommunication network. The TCP segments are sent to the PDCP layer. When a TCP segment is not acknowledged within a predefined time, e.g. within the RTO, the TCP segment is retransmitted to the PDCP layer.

The TCP segments not being the retransmitted TCP segments are stored on a buffer as PDCP segments. This means that the PDCP layer keeps track of the PDCP segments passed to the RLC layer. However, the PDCP sequence numbering differs from the TCP sequence numbering. Therefore, before compressing the TCP segment headers, the TCP sequence number is extracted from a TCP segment, and a correspondence is created between the TCP sequence number and the PDCP sequence number.

When the PDCP layer receives a TCP segment, it is discarded if the corresponding original PDCP segment is already in the buffer. Further, TCP segments that have already been positively acknowledged by a TCP segment receiver are also discarded.

Because the TCP uses a technique known as the positive acknowledgement with retransmission, acknowledgements of TCP segments are received. When a TCP receiver positively acknowledges a TCP segment, the sequence number of the TCP segment is extracted from the acknowledgement message. In a preferred embodiment, the positive acknowledgement message announces the last byte of the correctly received TCP segment. As a result, all the PDCP segments whose corresponding TCP sequence numbers are equal to or lower than the TCP sequence number of the positively acknowledged TCP segment are removed from the buffer. If a negative acknowledgement is received for a PDCP segment from the RLC layer, the PDCP segment is retransmitted from the buffer to the RLC layer.

The present invention describes also a Discarding TCP Packets (DTCPP) protocol entity that is in the preferred embodiment added to the PDCP layer. If the DTCPP is added to the PDCP layer, it has the knowledge of successfully received segments. When the flow of retransmitted segments reach the PDCP layer, the DTCPP performs the following operations:

The DTCPP drops those TCP segments that have successfully received on the TCP segment receiver side. There is no need to retransmit them again over the air interface, if they have been successfully received.

The remaining segments of the retransmitted segment stream do not have to be stored because their original versions are already in the PDCP layer. Then, the DTCPP monitors the successful/unsuccessful transmission of those original versions. If there is any segment not successfully transmitted, the DTCCP will retransmit it again over the air interface.

The DTCPP may use some algorithm to let a retransmitted segment be passed to the RLC, if this specific segment is multiple times retransmitted. In this way, the packets retransmitted by the server will not pass through the air interface, if they have been successfully received.

The present invention has several advantages over the prior-art solutions. The invention overcomes the problem of unnecessary retransmissions over the air interface.

Due to the present invention, unnecessary retransmission of a TCP segment can be avoided despite the fact that the TCP segment headers are encoded, and the fact that the whole segment is chopped at the RLC buffer, which makes the comparison between the original version and the copied one impossible. With the DTCPP, copied versions are not passed to the RLC buffer, if they are already existing in the buffer.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates the different situations where an original TCP segment can be when the retransmission of the TCP segment occurs in a wireless telecommunication network,

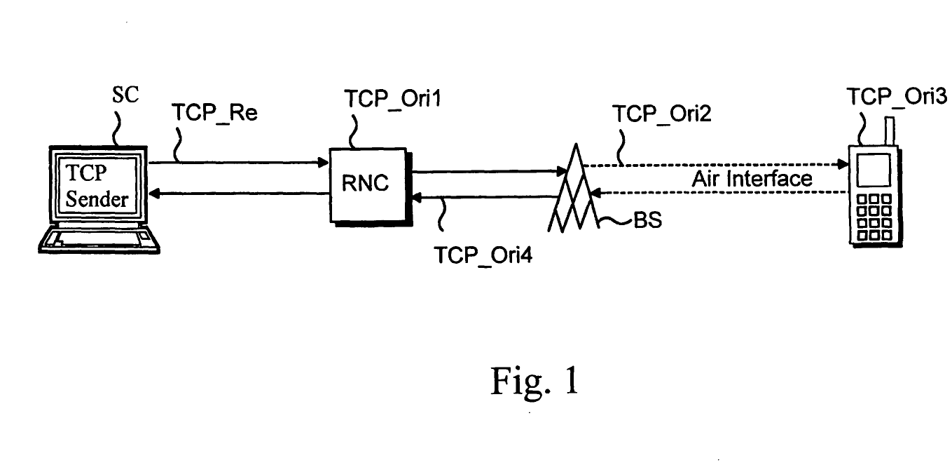

FIG. 2 is a block diagram illustrating the DTCPP entity and the location of the DTCPP entity,

FIG. 3 is a flow diagram illustrating the actions when an acknowledgement is received,

FIG. 4 is a flow diagram illustrating the actions when a TCP segment is received,

FIGS. 5a and 5b describe flow diagrams illustrating the packet flow between the PDCP, RLC and TCP layers and the DTCPP operation,

FIG. 6 is a graph illustrating the average number of TCP timeouts for different bitrates and different TCP packet sizes as a function of different page sizes, and

FIG. 7 is a graph illustrating the capacity used for unnecessary retransmissions, due to TCP timeouts, compared to the capacity needed for different bitrates and different TCP packet sizes as a function of different page sizes.

### DETAILED DESCRIPTION OF THE INVENTION

Reference will now be made in detail to the embodiments of the present invention, examples of which are illustrated in the accompanying drawings.

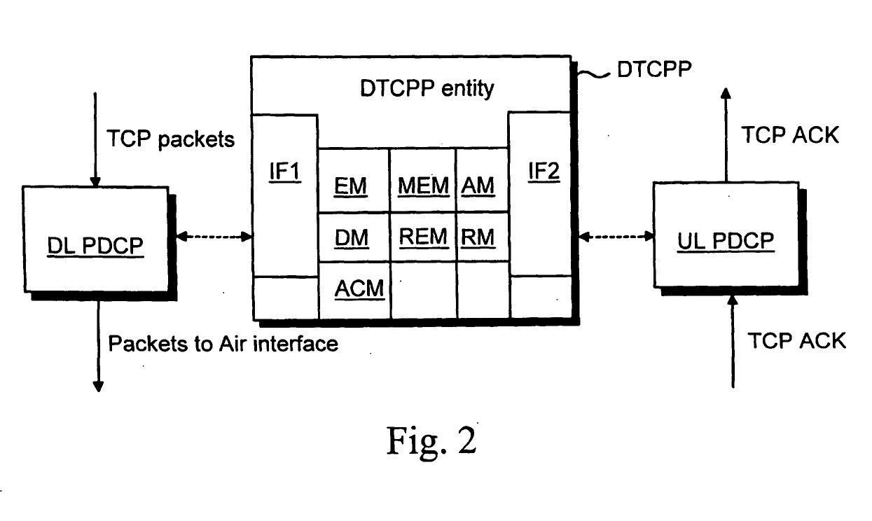

FIG. 2 is a block diagram illustrating the DTCPP (Discarding TCP packets) entity and the location of the DTCPP entity. In a preferred embodiment, the DCTPP entity is located in the PDCP layer. The DTCPP entity has to have an access to the TCP segment flow to the PDCP layer. Further, the DTCPP entity has to have the knowledge of which TCP segments have been successfully received by the TCP receiver. This information can be gained by reading the TCP acknowledgements at the uplink (UL) PDCP. Therefore, the DTCPP entity comprises a first interface IF1 for reading the TCP segment flow to the PDCP layer and RLC acknowledgements from the RLC layer, and a second interface IF2 for reading TCP acknowledgements from a TCP receiver. The TCP receiver is preferably a wireless mobile terminal, e.g. a mobile phone.

When a TCP segment arrives at the PDCP layer, the TCP segment header is compressed and the corresponding PDCP segment is sent to the RLC layer below the PDCP layer. When the TCP segment header compression is done, it is not any more possible to acquire the TCP sequence number of a TCP segment. The PDCP layer stores the PDCP segments sent to the RLC layer on a PDCP buffer for SRNS lossless relocation purposes. The DTCPP entity comprises means for extracting EM the TCP sequence number from a TCP segment before the header compression. The TCP sequence number and the corresponding PDCP sequence number are stored on a memory MEM.

When a TCP segment is transmitted to the DL PDCP, the DTCPP entity becomes active. The DCTPP entity extracts the TCP sequence number from the TCP segment. The DTCPP entity accesses the memory MEM and checks the TCP sequence number corresponding to the PDCP sequence numbers. Next, the DTCPP entity accesses the buffer in the PDCP layer and the TCP sequence numbers corresponding to the PDCP segments stored on the memory. Therefore, the DTCPP entity comprises means for accessing ACM the buffer in the PDCP layer wherein the PDCP segments transmitted to the RLC layer are stored. If the PDCP segment whose corresponding TCP sequence number is the same as the TCP sequence number of the TCP segment received is in the buffer, the DTCPP discards the TCP segment. There is no need to store the retransmitted TCP segment, because its original version is already in the PDCP layer buffer. Therefore, the DTCPP entity comprises means for discarding DM a retransmitted TCP segment whose original version is already in the buffer.

It may occur that the DL PDCP receives a retransmitted TCP segment that has already been received by the TCP-UE. This information can be gained by reading the TCP acknowledgement messages at the UL PDCP, where the sequence number of the correctly received byte is stated. Let “limit A” refer to the last acknowledged segment by the TCP-UE. In this way the DTCPP entity is informed of the successfully received segments. When the flow of retransmitted segments reach the PDCP-RNC, the DTCPP drops those TCP segments whose sequence number is equal to or lower than the limit A. Therefore, the DTCPP entity comprises means for discarding DM a TCP segment that has already been received by the TCP-UE.

If the RLC layer informs the DL PDCP of the fact that a PDCP segment was successfully transferred, nothing is dropped from the buffer in the PDCP layer. The acknowledgement message from the RLC layer can naturally be also a negative acknowledgement message of a PDCP segment. The PDCP segment number is extracted from the negative acknowledgement message, and the PDCP segment corresponding to the PDCP sequence number is retransmitted from the buffer in the PDCP layer to the RLC layer. Therefore, the DTCPP entity comprises means for retransmitting RM a PDCP segment from the buffer to the RLC layer, when a negative acknowledgement for a PDCP segment is received from the RLC layer.

When a transmitted TCP segment is acknowledged, the UL PDCP receives a PDCP-PDU that is a TCP segment carrying the TCP acknowledgement of what TCP segment was successfully received by the TCP-UE. The UL PDCP applies decompression and then the DTCPP entity extracts the TCP sequence number from the acknowledgement message and checks the TCP sequence numbers corresponding to the PDCP segments in the buffer by accessing the memory MEM. Based on the information from the memory MEM and the buffer, the DTCPP entity removes PDCP segment(s) from the buffer. In a preferred embodiment, the acknowledgement message announces the last byte of the correctly received TCP segment. As a result, all the PDCP segments whose corresponding TCP sequence numbers are equal to or lower than the limit A are removed from the buffer.

Therefore, the DTCPP entity comprises means for removing REM PDCP segment(s) from the buffer when the TCP-UE positively acknowledges a TCP segment. Only a positive acknowledgement message of a TCP segment from the TCP-UE leads to the dropping of PDCP segment(s) from the buffer in the PDCP layer.

The DTCPP entity usually discards all the retransmitted TCP segments arriving at the PDCP layer. There can, however, be an option that when a TCP segment is multiple times retransmitted, it can be allowed to be stored on the buffer. Therefore, the DTCPP entity comprises means for allowing AM a retransmitted TCP segment to be sent to the RLC layer. This action follows the normal procedure as if no DTCPP entity were present at all. The reception of several (e.g. three) duplicated acknowledgement messages indicate that one of the segments stored in the DTCPP entity reached the PDCP-UE destination, but did not reach the TCP-UE destination. Thus, the aforementioned segment must be passed again to the RLC layer and therefore stored as normal segments on the PDCP layer.

The DTCPP entity and the aforementioned means in FIG. 2 are in a preferred embodiment implemented by software components.

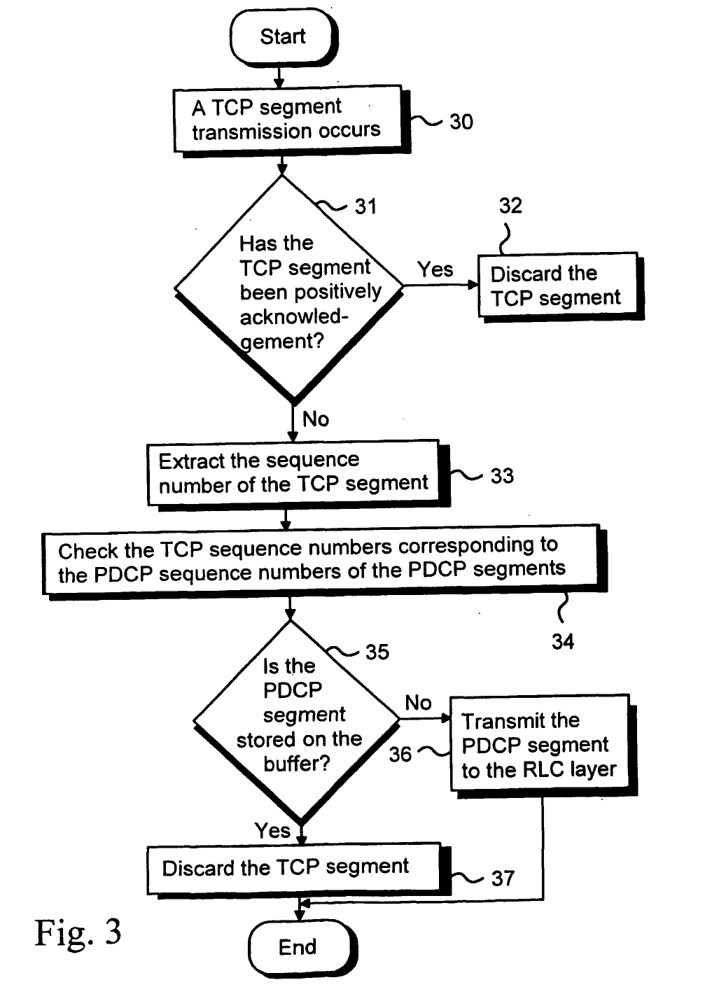

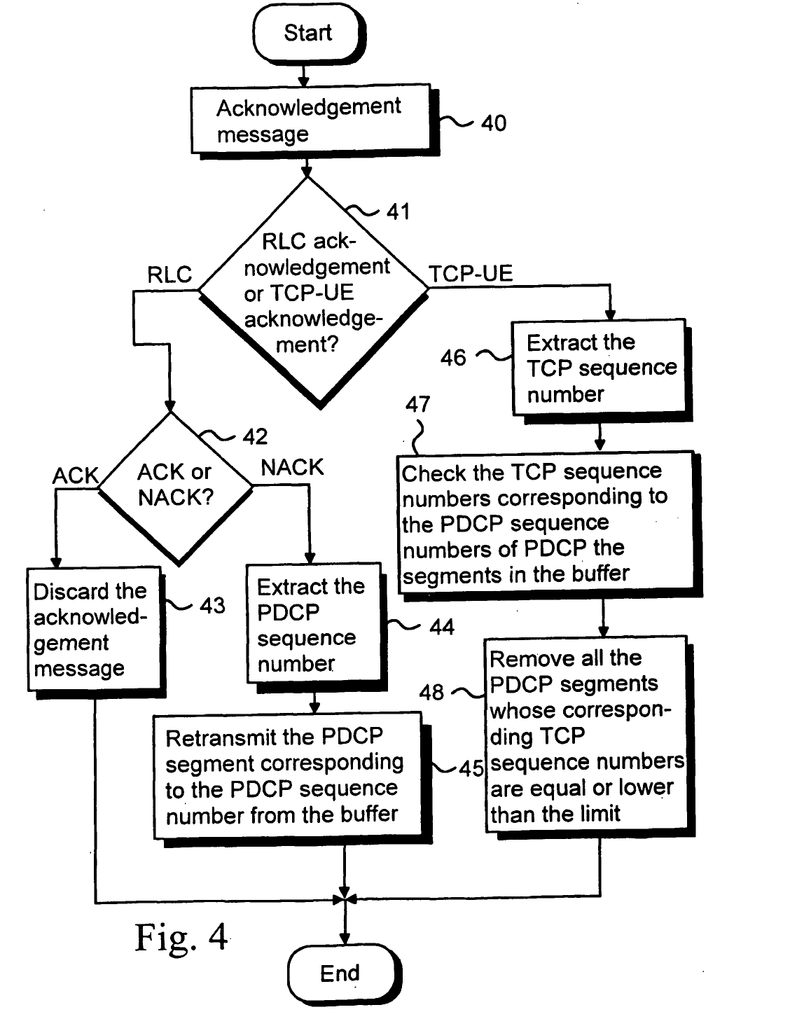

FIG. 3 is a flow diagram illustrating the actions when a TCP segment is received. As shown in block 30, a TCP sender sends a TCP segment to the PDCP layer. At this stage, it is not relevant whether the TCP segment is a retransmitted TCP segment or not. In the decision box 31 it is decided, if the TCP segment has already been positively acknowledged. If the TCP segment has already been positively acknowledged the TCP segment is discarded, as shown in block 32. Acknowledgements are discussed in more detail in the description of FIG. 4.

Every time a TCP segment is passed to the RLC layer, the DTCPP entity of FIG. 2 creates a correspondence between the TCP sequence number and the PDCP sequence number and stores the correspondence information on a memory. The PDCP layer stores the PDCP segments (PDCP-PDUs) sent to the RLC layer on a PDCP buffer for SRNS lossless relocation purposes. The PDCP-PDUs sent to the RLC layer are basically TCP segments with the exception that the PDCP sequence numbering is different than the TCP sequence numbering.

If the TCP segment has not been positively acknowledged, the TCP sequence number is extracted from the TCP segment before header compression in the PDCP layer, as shown in block 33. Because the TCP segment/PDCP segment sequence numbering information is stored by the DTCPP entity, it can check the TCP sequence numbers corresponding to the PDCP sequence numbers of the PDCP segments in the buffer, as shown in block 34.

In the decision box 35 it is decided, if the PDCP segment is already stored on the buffer in the PDCP layer. The DTCPP entity accesses the buffer and the memory MEM and compares the TCP sequence number of the received TCP segment to the TCP sequence numbers of the PDCP segments in the buffer. Let limit A refer to the last acknowledged segment by the TCP receiver. When a retransmitted TCP segment is sent to the PDCP layer, the DTCPP drops those TCP segments whose sequence number is equal to or lower than the limit A. If the TCP sequence number of the received TCP segment does not match to any of the TCP sequence numbers of the PDCP segments in the buffer, then the TCP segment is not a retransmitted TCP segment but a first-time TCP segment. Therefore the corresponding PDCP segment is transmitted to the RLC layer, as shown in block 36. If a PDCP segment corresponding to the TCP sequence number is found in the buffer, or the corresponding TCP sequence number of the received TCP segment is equal to or lower than the limit A, the DTCPP entity discards the TCP segment, because it is a retransmitted TCP segment, as shown in block 37.

FIG. 4 represents a flow diagram illustrating the actions when an acknowledgement (block 40) is received. In the decision box 41 it is decided whether the acknowledgement message is a RLC acknowledgement message or a TCP-UE acknowledgement message.

If the acknowledgement message is a RLC acknowledgement message, it is decided whether the RLC acknowledgement message is a negative (NACK) or a positive (ACK) acknowledgement message of a PDCP segment, as shown in the decision box 42. If it is an ACK, the DL PDCP receives a positive acknowledgement message for a PDCP-PDU. The positive acknowledgement message is discarded, as in block 43, because it is not sure that it will be correctly received by the TCP-UE. The reason for this is that the checksum checking at the IP and TCP layers can still be unsuccessful.

If the acknowledgement message is a NACK, the PDCP sequence number is extracted from the acknowledgement message, as shown in block 44. Then, the DTCPP entity retransmits the PDCP segment from the buffer in the PDCP layer, as shown in block 45.

When the acknowledgement message is a TCP-UE acknowledgement message, the TCP sequence number is extracted from the acknowledgement message, as shown in block 46. Because the TCP segment/PDCP segment sequence numbering information is stored by the DTCPP entity, it can check the TCP sequence numbers corresponding to the PDCP sequence numbers of PDCP segments in the buffer, as shown in block 47. Let limit A refer to the last acknowledged segment by the TCP-UE. Then, the DTCPP entity removes all the PDCP segments whose corresponding TCP sequence numbers are equal to or lower than the limit A from the buffer, as shown in block 48.

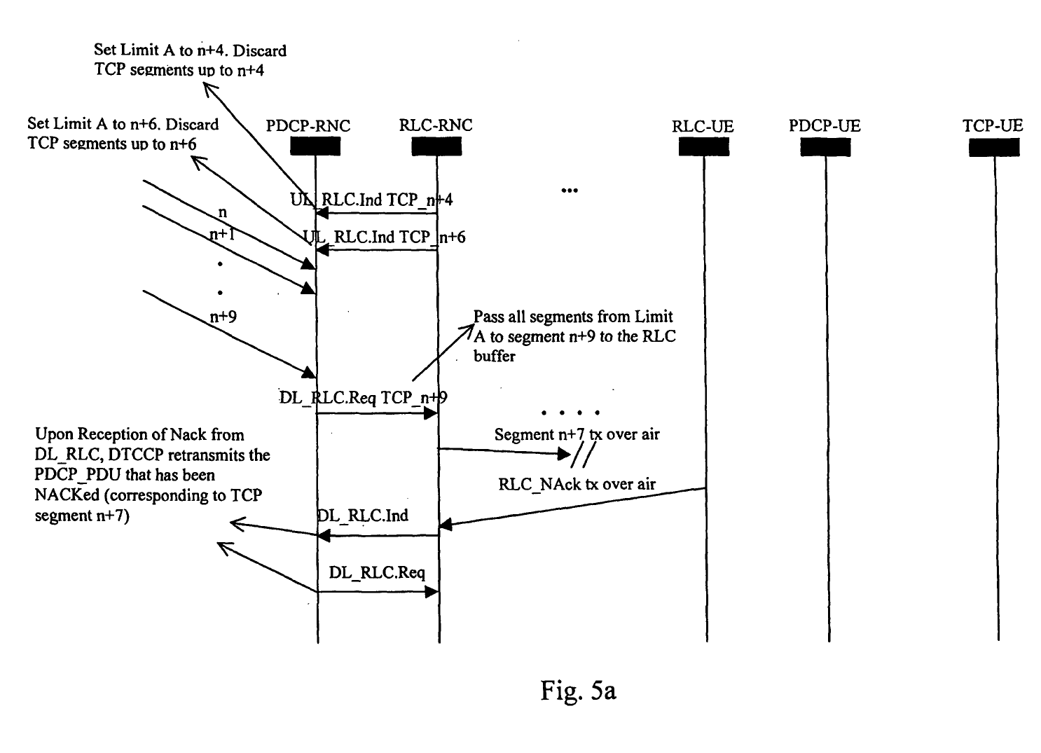

FIGS. 5a and 5b describe flow diagrams illustrating the packet flow between the PDCP, RLC and TCP layers and the DTCPP operation in a wireless communications system. FIGS. 5a and 5b comprise five parties. Two of them are on the sending side (PDCP-RNC and RLC-RNC) and three of them are on the receiving side (RLC-UE, PDCP-UE and TCP-UE). FIG. 5a starts from the situation where the RLC-RNC sends UL_RLC.Ind TCP_n+4 and UL_RLC.Ind TCP_n+6 messages to the PDCPRNC. Let limit A refer to the last acknowledged segment by the TCP-UE. The first message (RLC.Ind TCP_n+4) indicates that TCP segments up to n+4 can be discarded from the buffer in the PDCP layer. The limit A is thus set to n+4. Correspondingly, the second message (RLC.Ind TCP_n+6) indicates that TCP segments up to n+6 can be discarded from the buffer in the PDCP layer. This means that the TCP-UE has received segments up to n+6 correctly. Now the limit A is set to n+6. DL_RLC.Req TCP_n+9 message means here that all segments from the limit A up to n+9 are passed to the RLC buffer if they have not been passed to the RLC layer before.

The RLC-RNC tries to transmit the PDCP-PDU corresponding to the segment n+7 over the air interface to the RLC-UE. However, the segment n+7 is lost. At a certain point in the downlink direction, the RLC-RNC informs (DL_RLC.Ind) the PDCP-RNC that the PDCP-PDU corresponding to the segment n+7 has not been successfully sent (the RLC-UE sends a negative acknowledgement message (RLC_NAck) to the RLC-RNC). Therefore, the DTCPP retransmits (DL_RLC.Req) the PDCP-PDU (corresponding to the TCP segment n+7) that has been negatively acknowledged to the RLC-RNC.

In the beginning of FIG. 5b, the transmission of PDCP-PDUs corresponding to the segments n+8 and n+9 occur. These PDCP-PDUs reach the PDCP-UE and TCP-UE correctly. The TCP-UE, however, sends an acknowledgement message for the n+6 segment because it did not receive the segment n+7 at all and thus is still expecting it. Therefore, in the uplink the reception of the segments n+8 and n+9 cannot produce any other acknowledgement message than the acknowledgement message of the segment n+6.

Now the RLC-RNC transmits the PDCP-PDU corresponding to the segment n+7 to the RLC-UE. The segment reaches the TCP-UE. The TCP-UE can restructure segments n+7, n+8 and n+9 (and all previous ones) and can now acknowledge everything up to the segment n+9. When the UL_RLC.Ind TCP_n+9 acknowledgement message is received, limit A can be set to n+9 and segments up to n+9 dropped from the buffer in the PDCP layer.

In one embodiment of FIGS. 5a and 5b, the PDCP-RNC keeps the PDCP-PDUs that are acknowledged by the RLC-RNC but not by the TCP-UE. However, the PDCP specification says that for SRNS relocation the PDCP layer shall provide unconfirmed PDCP-SDUs and sequence numbers for forwarding to the target RNC. So as soon as the PDCP-PDU is confirmed by the RNC it is not stored in the PDCP-RNC anymore. Therefore, the DTCPP catches the positive RLC-RNC acknowledgement messages before they reach the PDCP-RNC. When a positive acknowledgement message is received for a TCP segment from the TCP-UE, the DTCPP removes PDCP segment(s) whose corresponding TCP sequence numbers are equal to or lower than the limit A from the PDCP-RNC buffer. If three duplicated uplink acknowledgements are detected in uplink flow or in downlink direction the RLC-RNC negatively acknowledges a PDCP-PDU, the DTCPP computes which PDCP-PDU is the missing TCP segment and resends it to the RLC-RNC.

In another embodiment of FIGS. 5a and 5b, the DTCPP keeps the PDCP-PDUs that are acknowledged by the RLC-RNC but not by the TCP-UE. The PDCP specification says that for SRNS relocation the PDCP layer shall provide unconfirmed PDCP-SDUs and sequence numbers for forwarding to the target RNC. So, as soon as the PDCP-PDU is confirmed by the RNC, it is not stored in the PDCP-RNC anymore. Therefore, the DTCPP stores the PDCP-PDU confirmed by the RLC-RNC before the PDCP-RNC drops it from the PDCP-RNC buffer. When a positive acknowledgement message is received for a TCP segment from the TCP-UE, the DTCPP removes PDCP segment(s) whose corresponding TCP sequence numbers are equal to or lower than the limit A from the PDCP segments it had earlier stored.

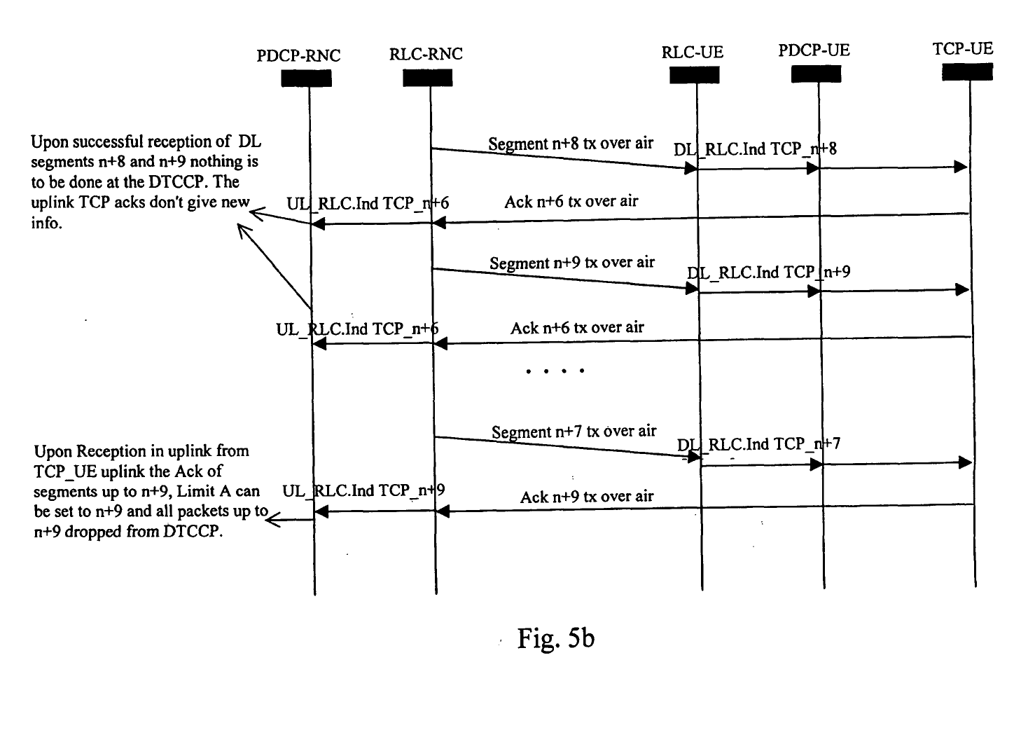

FIG. 6 is a graph illustrating the average number of TCP timeouts for different bitrates and different TCP packet sizes as a function of different page sizes. In FIG. 6, the average number of timeouts for the UTRAN (UTRAN, UMTS Terrestrial Radio Access Network; UMTS, Universal Mobile Telecommunications System) can be seen in the case of 64 and 128 kbps. The TCP block size is equal to 1500 and 576 Bytes, the fixed RTT delay in the network equalises 130 ms and the Block Error Ratio (BLER) is 10%. Results for page sizes of 100, 200 and 500 kbit can be seen. Note that these results do not contain timeouts caused by bitrate modifications, packet scheduling, or channel delay set-ups, so therefore these figures can be considered lower bounds. It can be seen that for a page size of 200 kbit, the average number of TCP timeouts is about 1, and increases with the page size.

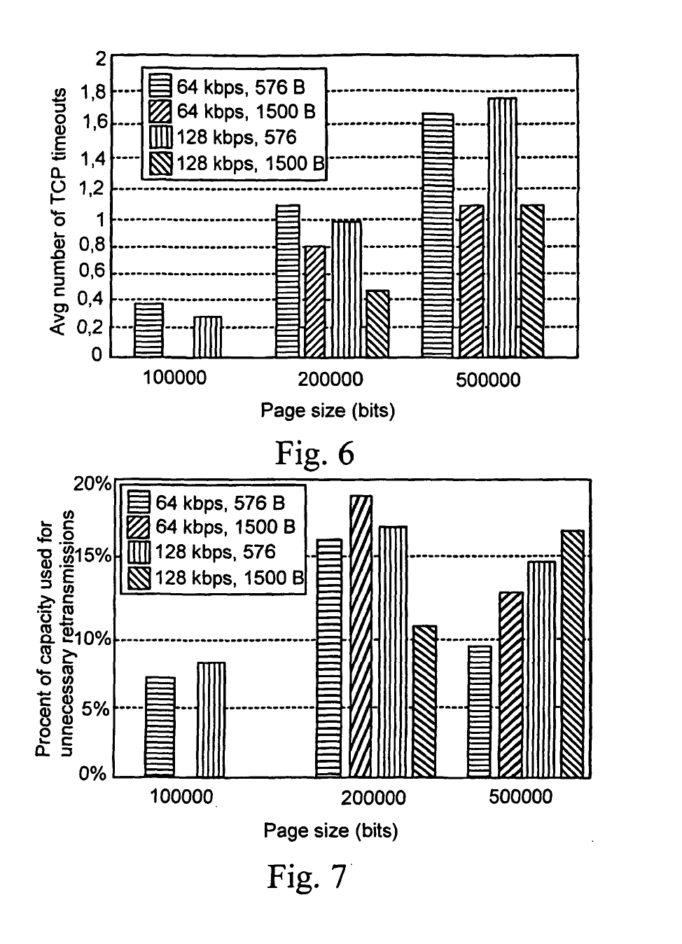

FIG. 7 is a graph illustrating the capacity used for unnecessary retransmissions, due to TCP timeouts, compared to the capacity needed for different bitrates and different TCP packet sizes as a function of different page sizes. The percentage of the capacity used for the unnecessary retransmissions, due to the TCP timeouts, can be seen in FIG. 7 for different TCP packet sizes and different bitrates as a function of different page sizes. It can be seen that up to 20% is wasted due to the TCP timeouts. This number is a minimum number and will be higher when bitrates are changed during transmission and when packet scheduling introduces further variations in delay. This waste of capacity can be avoided with the solution described in the present invention.

Whenever a TCP timer of the sender expires, a retransmission at the TCP level has to be carried out. At this point, the TCP entity of the server retransmits all the segments that were pending, and the amount of retransmitted bytes is equal to the window size at the moment of the retransmission plus the TCP/IP headers (40 bytes each) corresponding to each retransmitted segment. If no intelligence is included in the RNC, all those retransmitted packets will be retransmitted again through the air interface, delaying the wireless download of the web page (or e-mail etc.), and thus wasting capacity.

There are two main reasons that may cause a time out:

1. The slow start algorithm behaviour. It has been shown that if the object to be downloaded (web page, e-mail, File Transfer Protocol (FTP), . . . ) is large enough, over 100 Kbytes, the TCP slow start will lead to a time out. Besides the web page (the object to be downloaded) size, there are other things that influence the occurrence of a time out:

Receiving user equipment (UE) buffering capabilities. Here the user equipment refers to a wireless mobile terminal. The window size of the transmitter is equal to the minimum of the receiver's advertised window and the congestion window (controlled by slow start and congestion window algorithms). For a mobile terminal with low buffering capabilities (16 kbytes), the receiver advertised window may limit the server transmission rate before large amounts of data are queued and delayed at the buffers of the RNC. For a mobile terminal with large buffering capabilities (32 kbps and beyond), the slow start algorithm continues increasing the server transmission rate until the delay at the RNC triggers the time out and therefore the retransmission of several TCP packets.

Initial measurement of the RTT. The server initialises the variable RTO at the TCP connection establishment. The TCP connection establishment is carried out with segments that only include the TCP/IP headers, and will probably be transmitted over the air interface on Forward Access Channel (FACH) and Random Access Channel (RACH) channels. The RACH and FACH are channels which can be allocated very fast, so this will produce an optimistic measurement of the total RTT. The next segments (including data) will experience longer delays due to the dedicated channels set-up time (which is considerably longer), scheduling delays and queuing delays. This leads to a high probability of a TCP time out.

2) In the air interface, the link bitrate may vary very fast, due to the movement of the UE and changing radio conditions. This will lead to a delay, which varies a lot from one TCP block to another. The RTO may not be adapted fast enough, which will lead to TCP time outs. Also the packet-scheduling algorithm can have a huge impact on the changing delay. One can, for example think of a low priority user which is put in the queue, as soon as a new higher priority user arrives. This user is likely to have a lot of TCP time outs. Moreover, high Block Error Ratio (BLER) operating points may delay too much the transmission of certain RLC-PDUs between RLC peer entities, which would delay the involved TCP segments, and therefore may trigger a time out.

As described above, the DTCPP entity is in a preferred embodiment added to the PDCP protocol, since the PDCP reads all headers anyway. However, the DTCPP entity can be added to any other protocol or layer provided that it has an access to exchanged primitives between the PDCP layer and RLC layer, and is able to deliver packets to the RLC layer. The receiving RLC layer, receiving PDCP layer and TCP receiver can be located in the user equipment (UE) and/or in the radio network controller. (RNC) of the wireless telecommunication network. Correspondingly, the originating PDCP layer and originating RLC layer can be located in the user equipment (UE) and/or in the radio network controller (RNC) of the wireless telecommunication network.

The present invention can be used in any wireless communications system, e.g. in the Internet Protocol Radio Access Network (IPRAN) of the Universal Mobile Telecommunications System (UMTS).

It is obvious to a person skilled in the art that with the advancement of technology, the basic idea of the invention may be implemented in various ways. The invention and its embodiments are thus not limited to the examples described above, instead they may vary within the scope of the claims.

1. A method for managing the dispatching of TCP segments in a wireless telecommunication network, wherein the method comprises the step of:
sending TCP segments to a PDCP layer;
characterised in that the method further comprises the steps of:
storing TCP segments on a buffer as PDCP segments, said TCP segments not being said retransmitted TCP segments;
discarding those TCP segments whose corresponding original PDCP segments are already in said buffer;
discarding those TCP segments that have already been positively acknowledged by a TCP receiver;
removing PDCP segment(s) from said buffer based on a positive TCP acknowledgement message from said TCP receiver; and
if a negative acknowledgement is received for a PDCP segment from the RLC layer, retransmitting the PDCP segment from said buffer to said RLC layer.

2. The method according to claim 1, characterised in that the method comprises the steps of:
extracting the TCP sequence number from a TCP segment before compressing the TCP segment header;
creating a correspondence between the TCP sequence number and the PDCP sequence number;
storing said correspondence information; and
storing said TCP segments on a buffer in the PDCP layer as PDCP segments.

3. The method according to claim 1 or 2, characterised in that storing the TCP sequence number of the last positively acknowledged TCP segment as a limit A.

4. The method according to any of the claims 1, 2 or 3, characterised in that the method comprises the steps of:
receiving a positive acknowledgement message for a TCP segment from said TCP receiver;
extracting the TCP sequence number from said positive acknowledgement message;
checking the TCP sequence numbers of the PDCP segments in said buffer; and
removing all the PDCP segment(s) whose corresponding TCP sequence numbers are equal to or lower than said limit A from said buffer.

5. The method according to claim 1 or 2, characterised in that the method comprises the steps of:
reading acknowledgement messages from said RLC layer; and when an acknowledgement message is a negative acknowledgement message of a PDCP segment,
extracting the PDCP sequence number from said negative acknowledgement message; and
retransmitting the PDCP segment corresponding to said PDCP sequence number from said buffer to said RLC layer.

6. The method according to claim 1 or 2, characterised in that the method comprises the steps of:
reading acknowledgement messages from said RLC layer; and when an acknowledgement message is a positive acknowledgement message of a PDCP segment, discarding said positive acknowledgement message.

7. The method according to claim 1, characterised in that the method comprises the step of:
allowing a retransmitted TCP segment to be sent to said RLC layer.

8. A protocol entity arranged for managing the dispatching of TCP segments in a wireless telecommunication network,
characterised in that the protocol entity comprises:
a first interface (IF1) for reading the TCP segment flow to the PDCP layer and RLC acknowledgements from the RLC layer;
a second interface (IF2) for reading TCP acknowledgements from a TCP receiver;
means for extracting (EM) a TCP sequence number from a TCP segment before header compression;
a memory (MEM) for storing the correspondence information between a TCP sequence number and a PDCP sequence number;
means for accessing (ACM) a buffer in the PDCP layer wherein the PDCP segments transmitted to said RLC layer are stored;
means for discarding (DM) a TCP segment whose original version is already in said buffer;
means for discarding (DM) a TCP segment that has already been positively acknowledged by the TCP receiver;
means for removing (REM) PDCP segment(s) from said buffer based on a positive TCP acknowledgement message from said TCP receiver; and
means for retransmitting (RM) a PDCP segment from said buffer to said RLC layer when a negative acknowledgement is received for the PDCP segment.

9. The protocol entity according to claim 8, characterised in that the protocol entity comprises a memory (MEM) for storing the TCP sequence number of the last positively acknowledged TCP segment as a limit A.

10. The protocol entity according to claim 8 or 9, characterised in that the protocol entity comprises means for allowing (AM) a retransmitted TCP segment to be sent to said RLC layer.

11. The protocol entity according to any of the claims 8, 9 or 10, characterised in that the protocol entity is arranged in said PDCP layer.

12. A system for managing the dispatching of TCP segments in a wireless telecommunication network, said wireless telecommunication network comprising at least:
an originating PDCP layer (PDPC-RNC) receiving TCP segments;
an originating RLC layer (RLC-RNC) receiving PDCP segments from said PDCP layer;
a receiving RLC layer (RLC-UE);
a receiving PDCP layer (PDCP-UE);
a TCP receiver (TCP-UE);
characterised in that the system comprises a protocol entity (DTCPP) comprising:
a first interface (IF1) for reading the TCP segment flow to said originating PDCP layer (RNC-PDCP) and RLC acknowledgements from the originating RLC layer (RLC-RNC);
a second interface (IF2) for reading TCP acknowledgements from said TCP receiver (TCP-UE);
means for extracting (EM) the TCP sequence number from a TCP segment before header compression;
a memory (MEM) for storing the correspondence information between a TCP sequence number and a PDCP sequence number;
means for accessing (ACM) a buffer in said originating PDCP layer (RNC-PDCP) wherein the PDCP segments transmitted to said RLC layer are stored;
means for discarding (DM) a TCP segment whose original version is already in said buffer;
means for discarding (DM) a TCP segment that has already been positively acknowledged by said TCP segment receiver (TCP-UE);
means for removing (REM) PDCP segment(s) from said buffer based on a positive TCP acknowledgement message from said TCP receiver (TCP-UE); and
means for retransmitting (RM) a PDCP segment from said buffer when a negative acknowledgement is received for the PDCP segment.

13. The system according to claim 12, characterised in that the system comprises a memory (MEM) for storing the TCP sequence number of the last positively acknowledged TCP segment as a limit A.

14. The system according to claim 12 or 13, characterised in that the system comprises means for allowing (AM) a retransmitted TCP segment to be sent to said originating RLC layer.

15. The system according to any of the claims 12, 13 or 14, characterised in that said protocol entity (DTCPP) is arranged in said originating PDCP layer.

16. The system according to any of the claims 12, 13, 14 or 15, characterised in that said receiving RLC layer, receiving PDCP layer and TCP receiver are located in the user equipment (UE) and/or in the radio network controller (RNC) of the wireless telecommunication network.

17. The system according to any of the claims 12, 13, 14, 15 or 16, characterised in that said originating PDCP layer and originating RLC layer are located in the user equipment (UE) and/or in the radio network controller (RNC) of the wireless telecommunication network.

18. The system according to any of the claims 12, 13, 14, 15 or 16, characterised in that said wireless telecommunication network is the Universal Mobile Telecommunications System (UMTS).
